(19) United States
(12) Patent Application Publication
(10) Pub. No.: US 2024/0325989 A1
(43) Pub. Date: Oct. 3, 2024

(54) COMPOSITE SEPARATION MEDIA

(71) Applicant: Donaldson Company, Inc., Bloomington, MN (US)

(72) Inventors: Matthew P. Goertz, Bloomington, MN (US); Stephen K. Sontag, Plymouth, MN (US); Bradly G. Hauser, Minneapolis, MN (US)

(21) Appl. No.: 18/621,873

(22) Filed: Mar. 29, 2024

Related U.S. Application Data
(60) Provisional application No. 63/455,843, filed on Mar. 30, 2023.

(51) Int. Cl. B01D 69/14; B01D 69/12; B01D 71/60; B01J 47/127

(52) U.S. Cl. CPC B01D 69/147; B01D 69/1214; B01D 69/1216; B01D 69/125; B01D 71/601; B01J 47/127; B01D 2323/12; B01D 2323/30

(57) ABSTRACT

A layered separation media includes a fibrous layer including a non-woven media; and a first coating disposed on the non-woven media, the first coating comprising a crosslinked hydrogel; and a membrane layer including a membrane; and a second coating disposed on the membrane. The second coating may also include a crosslinked hydrogel. The layered separation media may be used in a system for membrane chromatography. A method of separating a protein from a liquid stream may include flowing the liquid stream through the layered separation media. The protein may bind with functional groups in the hydrogel. The layered separation media may have a DBC10 of 50 mg/mL or greater.

### CROSS-REFERENCE TO RELATED APPLICATION

This application claims the benefit of U.S. Provisional Patent Application No. 63/455,843, filed Mar. 30, 2023, which is incorporated herein by reference in its entirety.

### FIELD

The present disclosure relates to layered separation media (e.g., composite media) useful for separation of biomolecules and ions, such as proteins. The layered separation media of the present disclosure may be used for separations in membrane chromatography. The present disclosure further relates to methods of making and using the layered separation media, and to filter units containing the layered separation media.

### BACKGROUND

Membranes may be used for separation of various compounds in liquid solutions. Separation membranes may be disposed, for example, in a column or cassette for membrane chromatography. However, membrane chromatography may be challenged by low capacity, slow speed, or both. Further improvements to separation membranes are desired.

### SUMMARY

A layered separation media includes a fibrous layer including a non-woven media; and a first coating disposed on the non-woven media, the first coating comprising a crosslinked hydrogel; and a membrane layer including a membrane; and a second coating disposed on the membrane. The second coating may also include a crosslinked hydrogel. The first coating, second coating, or both first and second coatings may include polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenehexamine, 2-(dimethylamino)ethyl acrylate, a copolymer of two or more thereof, a combination of two or more thereof, or a reaction product of two or more thereof.

The layered separation media may include an anion exchange media, a cation exchange media, a hydrophobic interaction membrane, a glycan affinity membrane, an antibody affinity membrane, an oligonucleotide affinity membrane, or mixed mode separation media with two or more separation modes, such as anion exchange, cation exchange, hydrophobic interaction, glycan affinity, antibody affinity, and oligonucleotide affinity. The layered separation media may have a DBC10 of 50 mg/mL or greater, measured using bovine serum albumin.

A system for membrane chromatography may include a layered separation media including a fibrous layer including a non-woven media; and a first coating disposed on the non-woven media, the first coating comprising a hydrogel; and a membrane layer including a membrane; and a second coating disposed on the membrane.

A method of preparing a layered separation media may include preparing a fibrous layer by: applying a first hydrogel onto a non-woven media; and optionally crosslinking the first hydrogel; preparing a membrane layer by: applying a second hydrogel onto a membrane; and optionally crosslinking the second hydrogel; and combining the fibrous layer with them membrane layer to form the layered separation media.

A method of separating a protein from a liquid stream may include flowing the liquid stream through a layered separation media including a fibrous layer including a non-woven media; and a first coating disposed on the non-woven media, the first coating comprising a hydrogel; and a membrane layer including a membrane; and a second coating disposed on the membrane.

### BRIEF DESCRIPTION OF FIGURES

FIG. 1 is a simplified schematic of a filter unit containing the layered separation media of the present disclosure according to an embodiment.

FIG. 2 is a graphical representation of the results of Example 1, showing a breakthrough curve for bovine serum albumin (BSA) obtained on a layered separation media according to an embodiment. The x-axis represents the filtration time, and the y-axis represents the absorbance of the filtrate at 280 nm and is indicative of the concentration of BSA.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

A “gel” is a crosslinked polymer network swollen in a liquid medium. The network retains the liquid.

A “hydrogel” is a gel where the liquid medium is water. In its swollen state, a hydrogel contains 10% or more of water by weight of the hydrogel.

The term “fibrous” is used here to refer to materials made from a plurality of individual fibers, the fibers having at least two discrete ends.

The term “membrane” is used here to describe a continuous (optionally porous) body that lacks individual fibers having discrete ends.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof.

Furthermore, unless otherwise specifically limited, the term “polymer” shall include all possible geometrical configurations of the material. These configurations include, but are not limited to, isotactic, syndiotactic, and atactic symmetries.

The term “aromatic ring” is used in this disclosure to refer to a conjugated ring system of an organic compound. Aromatic rings may include carbon atoms only, or may include one or more heteroatoms, such as oxygen, nitrogen, or sulfur.

The term “alkylated” is used in this disclosure to describe compounds that are reacted to replace a hydrogen atom or a negative charge of the compound with an alkyl group, such that the alkyl group is covalently bonded to the compound.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “substantially” as used here has the same meaning as “significantly,” and can be understood to modify the term that follows by at least about 90%, at least about 95%, or at least about 98%.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure relates to layered separation media (e.g., composite media) useful for separation of biomolecules, such as proteins. The present disclosure relates to layered separation media having a high binding capacity (e.g., protein binding capacity, such as BSA binding capacity). According to an embodiment, the layered separation media includes at least a first layer and a second layer, where the first layer is a fibrous layer and the second layer is a membrane layer. The fibrous layer may include non-woven or woven media coated with a first coating including a crosslinked hydrogel. The membrane layer may include a membrane coated with a second coating. The second coating may also include a crosslinked hydrogel. The fibrous layer may be arranged on the upstream side of the membrane layer.

The layered separation media of the present disclosure may be suitable for the separation of biomolecules, such as proteins, from solution. The biomolecules interact with various functional groups of the first and second coatings. One or both of the first and second coatings may be a hydrogel. In some cases, the gel can be characterized as a non-porous or homogenous gel. The gel may be free of pore forming components. Applicant has found that the coating materials interact with the target molecules (e.g., biomolecules) primarily via an absorption mechanism, as opposed to adsorption. One or both of the first and second coatings may form relatively thick layers to provide increased coating volume available for absorption, as compared to conventional coated membranes.

The layered separation media of the present disclosure may be useful for separation, purification, detection, and filtration of products in the pharmaceutical industry, biotechnology, food, beverage, fine chemicals, and the like. In particular, the layered separation media may be used as a separation membrane in membrane chromatography. The hydrogel(s) may include various functional groups that exhibit different types of interactions with the target molecules. Examples of types of interactions include electrostatic interactions, affinity interactions, hydrophobic interactions, and the like. Examples of molecules or ions that can be separated using the layered separation media include proteins, such as albumins, γ-globulins, immunoglobulins (e.g., IgG, IgM, and IgE), recombinant proteins, polypeptides, interleukin-2, enzymes, monoclonal antibodies, trypsin, cytochrome C, myoglobulin, nucleic acids (e.g., DNA and RNA), nucleic-acid derived products, endotoxins, and the like.

According to an embodiment, the layered separation media is prepared by saturation coating the non-woven media and the membrane with the respective coating compositions. The non-woven media and the membrane are collectively referred to here as substrates. The coating compositions deposited on each substrate may be the same or different from one another. Unless otherwise stated, the coating compositions and their components can be used interchangeably on either substrate (the non-woven media or the membrane). The substrate may be coated with a coating composition, where the coating composition includes a solution of a polymer in a solvent. The coating composition may further include a crosslinker that may be activated after depositing the composition onto the substrate. The polymer of the coating composition may optionally be functionalized, either before or after deposition onto the substrate.

The hydrogels are generally obtained by polymerization of a monomer to produce a polymer, and optionally crosslinking the polymer. According to an embodiment, the polymer forming the hydrogel is soluble in a solvent. In some cases, the polymer is soluble in water. After depositing the polymer onto the substrate, the polymer may be crosslinked to reduce its solubility. For example, crosslinking the polymer may make it non-water soluble. The polymer may be further reacted to provide desired functionality (e.g., affinity to certain target molecules) or to adjust solubility. The polymer may be further reacted first and then crosslinked, or crosslinked first and then further reacted. Alternatively, the polymer may be further reacted before deposition onto the substrate. The polymer may be a reactive polymer to facilitate crosslinking or further reaction or both. In some cases, the polymer is soluble in organic solvents but not is water soluble. In such cases, the polymer may be deposited from an organic solvent. The deposited polymer may be further reacted to increase hydrophilicity and to obtain a hydrogel.

The coating composition may include a solvent or solvent mixture. Generally, the polymer is soluble in the solvent or solvent mixture. The coating composition may further include one or more crosslinking agents. The crosslinking agents may also be soluble in the solvent. The solvent or solvent mixture may be free or substantially free of poor solvents or non-solvents. The absence of non-solvents may help avoid the formation of pores in the gel.

The present disclosure further provides devices, e.g., filter devices, chromatographic devices, macromolecular transfer devices, and/or membrane modules that include the separation media of the present disclosure.

The separation media may include either an uncharged hydrogel or a charged hydrogel. In embodiments where the separation media includes an uncharged hydrogel, separation of one or more components from a liquid passed through the media may be effected by size exclusion. In embodiments where the separation media includes a charged hydrogel, separation of one or more components from a liquid passed through the media may be effected by electric interactions. In cases where the charged hydrogel exhibits a fixed charge and the charge of the solutes can be appropriately adjusted, the solutes may be separated even against their size gradient. For example, the pH value of a solution containing a mixture of proteins may be adjusted based on the isoelectric points of the proteins in the solution to selectively elute or retain certain proteins.

Separation may also be achieved by the inclusion of reactive functional groups in the hydrogel. Such functional groups may be used to provide a ligand or other binding site with affinity to specific molecules or ions. When a liquid containing the particular molecule or ion is passed through the separation media, the ligand or other binding site interacts with the molecule or ion, thereby absorbing the molecule or ion and/or slowing down its elution through the media. The molecule or ion may subsequently be desorbed by altering the environment, for example by changing the nature of the solvent passed through the separation media.

### Composition of the Gel

The composition of the hydrogel is a function of the coating composition, the method of applying and preparing the coating, and any optional crosslinking, functionalization, or other reactions that the coating may be subjected to. According to an embodiment, the coating composition deposited onto the substrate includes a polymer. Generally, the polymer may be obtained by polymerization of a monomer. The polymerization may be performed prior to preparation of the coating composition, or may be performed concurrently with the preparation of the coating composition. In some cases, it may be practical to use pre-formed polymers to prepare the coating composition. The polymer may be crosslinked either before or after formation of the coating composition. In some embodiments, the polymer is crosslinked only after (if at all) the deposition of the coating composition to reduce the solubility of the coating (e.g., hydrogel). The polymer may optionally be reacted to provide functionality (e.g., affinity to certain target molecules) or to adjust solubility. The polymer may be further reacted first and then crosslinked, or crosslinked first and then further reacted. Alternatively, the polymer may be further reacted before deposition onto the substrate. The polymer may be a reactive polymer to facilitate crosslinking or further reaction or both.

According to an embodiment, the crosslinked hydrogel of the coating includes a crosslinked polymer. The crosslinked polymer may be formed from a hydrogel precursor. That is, the coating composition applied onto the substrate may include a hydrogel precursor (e.g., a precursor polymer). According to an embodiment, the hydrogel precursor is a polymer which may be crosslinked and optionally further reacted to form the hydrogel. Suitable precursor polymers include those that are soluble in a solvent and are reactive and thus capable of crosslinking to form the hydrogel. In some embodiments, the precursor polymer is water soluble. Preferably the polymer is a reactive polymer that may be crosslinked with a crosslinking agent. Particularly, in cases where the precursor polymer is water soluble, the precursor polymer may be crosslinked after deposition. In cases where the precursor polymer is not water soluble, the precursor polymer does not necessarily need to be crosslinked after deposition. However, non-water soluble precursor polymers may be reacted to render the polymer more hydrophilic so that it can be formed into a hydrogel. On the other hand, if the polymer upon being reacted becomes hydrophilic to an extent that it becomes water soluble, the polymer may also be crosslinked to reduce solubility.

Examples of monomers that may be suitable for preparing the precursor polymers include acrylates, methacrylates, acrylamides, allyl or vinyl monomers, amines (including alkylencamines and ethyleneimines), amino acids, nucleotide bases, saccharides, and combinations thereof. Examples of suitable precursor polymers include polymers prepared from the above-listed monomers, including polyacrylates, polymethacrylates, polyacrylamides, polyolefins, polyamines, oligonucleotides, polynucleotides, peptides, polypeptides, proteins, enzymes, oligosaccharides, and mixtures, copolymers, and combinations thereof.

The precursor polymer may be a reaction product of one or more monomers including acrylamide, 2-acryloxyethyltrimethylammonium chloride, N-acryloxysuccinimide, N-acryloyltris(hydroxymethyl)methylamine, 2-aminoethyl methacrylate hydrochloride, N-(3-aminopropyl)methacrylamide hydrochloride, butyl acrylate and methacrylate, N,N-diethylacrylamide, N,N-dimethylacrylamide, 2-(N,N-dimethylamino)ethyl acrylate and methacrylate, N-[3-(N,N-dimethylamino)propyl]methacrylamide, N,N-dimethylacrylamide, n-dodecyl acrylate, n-dodecyl methacrylate, dodecyl methacrylamide, ethyl methacrylate, 2-(2-ethoxyethoxy)ethyl acrylate and methacrylate, 2,3-dihydroxypropyl acrylate and methacrylate, glycidyl acrylate and methacrylate, n-heptyl acrylate and methacrylate, 1-hexadecyl acrylate and methacrylate, 2-hydroxyethyl acrylate and methacrylate, N-(2-hydroxypropyl)methacrylamide, hydroxypropyl acrylate and methacrylate, methacrylamide, methacrylic anhydride, methacryloxyethyltrimethylammonium chloride, 2-(2-methoxy)ethyl acrylate and methacrylate, octadecyl acrylamide, octylacrylamide, octyl methacrylate, propyl acrylate and methacrylate, N-iso-propylacrylamide, stearyl acrylate, styrene, 4-vinylpyridine, vinylsulfonic acid, N-vinyl-2-pyrrodinone. Particularly preferred monomers include dimethyldiallylammonium chloride, acrylamido-2-methyl-1-propanesulfonic acid (AMPS), (3-acrylamidopropyl) trimethylammonium chloride (APTAC), acrylamide, methacrylic acid (MAA), acrylic acid (AA), 4-styrenesulfonic acid and its salts, acrylamide, glycidyl methacrylate, diallylamine, and diallylammonium chloride.

The precursor polymer may include polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenchexamine, 2-(dimethylamino)ethyl acrylate, a copolymer of two or more thereof, a combination of two or more thereof, or reaction product of two or more thereof. In one embodiment, the precursor polymer includes polyethyleneimine (PEI). In one embodiment, the precursor polymer includes a copolymer of 2-acrylamido-2-methyl-1-propanesulfonic acid and hydroxypropyl methacrylate. In one embodiment, the precursor polymer includes a copolymer of 2-acrylamido-2-methyl-1-propanesulfonic acid, hydroxypropyl methacrylate, and 3-methacryloxypropyltrimethoxysilane. In one embodiment, the precursor polymer includes polyglycidylmethacrylate. In one embodiment, the precursor polymer includes a copolymer of polyglycidylmethacrylate copolymerized with 3-methacryloxypropyltrimethoxysilane. In one embodiment, the precursor polymer includes a copolymer of glycidylmethacrylate and 2-(dimethylamino)ethyl acrylate.

### Additional Reagents

The coating composition may optionally include other materials such as crosslinking agents, reactants, other monomers, oligomers, and polymers (other than the precursor polymer), e.g., copolymers, and the like. The crosslinking agents, reactants, and other monomers, oligomers, and polymers may be further reacted with the precursor polymer. For the example, the crosslinking agents may be used (e.g., activated) to crosslink the precursor polymer after being deposited on the substrate. Additional reagents may be used to provide functionalization of the hydrogel. The other monomers, oligomers, and polymers may be used to impart hydrophilicity or hydrophobicity to the coating. In one embodiment addition of hydrophilic comonomers such as 2-hydroxyethyl methacrylate, 3-hydroxypropyl methacrylate, or acrylamide could be added to an inherently hydrophobic coating composition. The addition of these hydrophilic comonomers would increase the net hydrophilic content of the coating to increase the water content of the coating in application. In another embodiment addition of hydrophobic comonomers such as propyl methacrylate or n-hexyl methacrylate could be added to a inherently water soluble polymer. The addition of these hydrophobic comonomers would increase the net hydrophobic content of the coating, therefor altering a coating from water soluble to an insoluble hydrogel.

In some cases, the precursor polymer is capable of self-crosslinking and additional crosslinking agent is not needed. For example, a polyethyleneimine or an aminoacrylate copolymerized with a silane acrylate is capable of self-crosslinking upon curing.

### Crosslinking Agents

The polymer may be crosslinked using any suitable crosslinking agent. Suitable crosslinking agents include those capable of reacting with one or more types of functional groups in the polymer backbone or among pendant groups. In some embodiments, it may be desirable that crosslinking does not occur until after the coating is deposited. Crosslinking groups may be added as a separate chemistry or copolymerized with the hydrogel precursor. Examples of crosslinking agent functionalities capable of reacting with amines, whether present in either the polymer backbone or pendant groups, include epoxy, glycidyl, isocyano, carboxyl, and acid chloride. In some embodiments, the crosslinking agent is a polyglycidyl compound. Examples of crosslinking agent functionalities capable of reacting with carboxylic acids include alcohols, hydroxyls, and carbodiimides. Examples of crosslinking agent functionalities capable of reacting with glycidyl groups include amines, alcohols, hydroxyls, anhydrides, carboxylic acids, and thiols. Examples suitable polyglycidyl compounds include polyalkyleneglycol polyglycidylethers, such as ethyleneglycol diglycidyl ether and butyleneglycol diglycidyl ether. Examples of suitable copolymer crosslinkers include acrylate silanes in which self crosslink when exposed to residual water and increased temperature. In an exemplary embodiment, the crosslinking agent includes 1,4-butanedioldiglycidylether, epoxymethoxysilane such as (3-glycidyloxypropyl)trimethoxysilane (“GLYMO”), dextran, 3-methacryloxypropyltrimethoxysilane (“MEMO”), pentaethylenehexamine, or a combination of two or more thereof.

The crosslinking agent may be used at any suitable amount. In some cases, the crosslinking agent is present at 0.5 wt-% or greater, 1 wt-% or greater, or 5 wt-% or greater by weight of the coating composition. The crosslinking agent may be present at 25 wt-% or less, 20 wt-% or less, 15 wt-% or less, or 10 wt-% or less by weight of the coating composition. The crosslinking agent may be present at 0.5 wt-% to 25 wt-%, 1 wt-% to 20 wt-%, 5 wt-% to 20 wt-%, or 5 wt-% to 15 wt-% by weight of the coating composition.

### Functionalization

The hydrogel or hydrogel precursor may be functionalized to provide desired affinity to target ions or molecules. In some embodiments, the functionalization includes positively charged groups or negatively charged groups, rendering the hydrogel positively or negatively charged, respectively. Affinity groups may include anionic groups, cationic groups, zwitterionic groups, neutral groups, and any corresponding salts.

Depending on the affinity groups, the resulting layered separation media may be capable of operating in one or more separation modes. The resulting the layered separation media may be an anion exchange media. The resulting the layered separation media may be a cation exchange media. The resulting the layered separation media may be a hydrophobic interaction membrane. The resulting the layered separation media may be a glycan affinity membrane. The resulting the layered separation media may be an antibody affinity membrane. The resulting the layered separation media may be an oligonucleotide affinity membrane. The resulting the layered separation media may be a mixed mode separation media. Mixed mode separation media indicates a media that includes two or more separation modes (e.g., two or more of anion exchange, cation exchange, hydrophobic interaction, glycan affinity, antibody affinity, and oligonucleotide affinity).

In some embodiments, the polymer (e.g., hydrogel or hydrogel precursor) is reacted with compounds to covalently attach pendant groups to the polymer backbone. The functionalization may be added either before deposition of the coating composition (e.g., added to the hydrogel precursor), or after deposition of the coating composition, depending on the solubilities of the hydrogel precursor and the additional reagent used to provide the functionalization.

Examples of polyalkyleneamines include short chain polyalkyleneamines such as diethylenetriamine, triethylenetetramine, tertaethylenepentamine, and pentaethylenehexamine, and the like, and long chain polyalkylenamines, such as polyethyleneimine (PEI), both branched and linear isomers. A combination of short chain and long chain polyalkyleneamines may be used. The cationic groups can be attached to the polyalkyleneamine through suitable spacer groups. Some suitable reactants that can be used to provide a spacer group include glycidyl compounds (e.g., epichlorohydrin) or other epoxy compounds. In one embodiment, the hydrogel includes polyalkyleneimine having pendant quaternary ammonium groups provided through reaction of with glycidyltrimethylammonium chloride and crosslinked with 1,4 butanediol diglycidyl ether. In one embodiment, the hydrogel includes poly (allylamine hydrochloride) copolymer with epoxy groups created with epichlorohydrin and pendant cationic groups created through addition of glycidyltrimethylammoniumchloride.

The polymer may include reactive groups pendant to the backbone of the polymer. Reactive pendant groups a capable of coupling to additional chemical groups to provide functionality. Example reactive pendant groups include amine, carboxyl, carbonyl, epoxy, anhydride, azide, reactive halogen, or other groups. In one embodiment, the hydrogel precursor includes polyglycidyl methacrylate. They glycidyl group can be further functionalized using amines, alcohols, carboxylic acids, sodium sulfite, anhydrides, thiols, and other groups. In one embodiment polyglycidyl methacrylate is synthesized in acetone, deposited onto a substrate, and further reacted with aqueous diethylamine to produce a pendant tertiary amine anion exchange hydrogel coating. In one embodiment polyglycidyl methacrylate is synthesized in dimethylformamide, deposited onto a substrate, and further reacted with sodium sulfite and isopropanol in water to produce cation exchange coating. In one embodiment polyglycidyl methacrylate is synthesized in acetone, deposited onto a substrate, and further reacted with 3-aminophenylboronic acid to create an affinity coating for cis-diol containing biomolecules such as glycans. In one embodiment polyglycidyl methacrylate is synthesized in acetone, deposited onto a substrate, and further reacted with sodium sulfite and isopropanol in water to produce cation exchange coating. In one embodiment polyglycidyl methacrylate is synthesized in acetone, deposited onto a substrate, and further reacted with 2-mercaptopyride in water to produce a multimode ligand coating for purification of supercoiled DNA plasmids.

In some embodiments, the polymer is reacted with cationic groups. Examples of useful cationic groups or reagents include amines with various substitutions including secondary amines, tertiary amines, and quaternary amines. Examples also include functional groups containing aniline, indole, piperidine, pyridine, pyrimidine, pyrrolidine, pyrrole, guanidine, and imidazole.

In some embodiments, the polymer is reacted with anionic groups. Any suitable anionic group may be used, such as carboxylates, sulfonates, phosphonates, or the like.

Additional useful functionalities may include, for example, various affinity ligands capable of preferentially binding certain types of molecules (e.g., proteins). Examples of affinity ligands include amino acid ligands such as L-phenylalanine, tryptophan, or L-histidine to separate γ-globulins and immunoglobulins, antigen and antibody ligands such as monoclonal antibodies, protein A, recombinant protein A, protein G, or recombinant protein G to separate immunoglobulins from different media, dye ligands such as cibaron blue or active red to separate albumins and various enzymes, metal affinity ligands such as complexes of iminodiacetic acid (IDA) ligand with Cu²⁺, Ni²⁺, Zn²⁺, or Co²⁺ to separate various proteins such as histidine, lysozyme, or tryptophan from various media, oligonucleotides for separation of complimentary oligonucleotides.

### Solvent

The coating composition includes a solvent. Suitable solvents include those in which the precursor polymer is soluble. Preferably, the solvents have a boiling point below 120° C. for ease of removal though application of heat. Examples of suitable solvents include water, alcohols (ethanol, methanol, propanol, etc.), acetone, DMF (dimethylformamide), DMSO (dimethylsulfoxide), NMP (N-methylpyrrolidone), and combinations thereof. In some referred embodiments, the solvent is or includes water.

### Solids Content of Coating Composition

The coating composition may be prepared by dissolving the hydrogel precursor in a suitable solvent, and optionally mixing in any desirable crosslinking agents, reagents, and other monomers, oligomers, and polymers. The hydrogel precursor may be present in an amount of 0.5% or greater, 1% or greater, 2% or greater, 3% or greater, or 4% or greater by weight of the coating composition. The hydrogel precursor may be present in an amount of 10% or less, 8% or less, 6% or less, 5% or less, 4% or less, 3% or less, or 2.5% or less by weight of the coating composition. In some embodiments, the hydrogel precursor is present at 0.5% to 10% or from 1% to 5%. The solvent may be present in an amount of from about 40% to about 99% or from about 90% to about 99% by weight of the coating composition.

The total solids content (including the hydrogel precursor and any additional reagents, such as crosslinking agents) of the coating composition may be 2% or greater, 5% or greater, 10% or greater, 15% or greater, or 20% or greater by weight of the coating composition. The total solids content of the coating composition may be 50% or less, 40% or less, 30% or less, 25% or less, 20% or less, or 15% or less by weight of the coating composition. The total solids content of the coating composition may range from 2% to 50%, from 5% to 40%, or from 10% to 30% by weight of the coating composition.

The coating composition may be applied onto the fibrous substrate (e.g., nonwoven substrate) in an amount that results in a coating having a mass of 5% or greater, 10% or greater, 20% or greater, 30% or greater, 40% or greater, or 50% or greater, of the combined dry mass of the coated substrate. The coating may have a mass of 75% or less, 60% or less, or 50% or less, of the combined dry mass of the coated substrate. The coating may have a mass ranging from 5% to 75%, or 10% to 60% of the combined dry mass of the coated substrate.

The coating composition may be applied onto the membrane in an amount that results in a coating having a mass of 1% or greater, 5% or greater, 10% or greater, 15% or greater, 20% or greater, or 25% or greater, of the combined dry mass of the coated membrane. The coating may have a mass of 50% or less, 40% or less, or 30% or less, of the combined dry mass of the coated membrane. The coating may have a mass ranging from 1% to 50%, or 5% to 40% of the combined dry mass of the coated membrane.

### Composite Material

According to an embodiment, the layered separation media is a composite material that includes at least a first layer and a second layer. The first layer is a fibrous layer and the second layer is a membrane layer. Each of the layers includes at least one coated substrate. The fibrous layer may include a fibrous substrate coated with a first coating including a hydrogel. The hydrogel may be crosslinked. The fibrous substrate may be a non-woven media, a woven media, or a combination thereof. The membrane layer may include a membrane coated with a second coating. The second coating may also include a hydrogel. The hydrogel of the second coating may be crosslinked. The fibrous layer may be arranged on the upstream side of the membrane layer.

In some embodiments, the composite separation media includes more than one fibrous layer or more than one membrane layer. In some embodiments, the composite separation media includes more than one fibrous layer and more than one membrane layer. The various layers may be ordered in any desired order, as long as at least one fibrous layer (e.g., nonwoven layer) is upstream of at least one membrane layer. In one embodiment, the composite separation media includes two fibrous layers (e.g., two nonwoven layers) and one membrane layer, where the two fibrous layers are upstream of the membrane layer. The layers may further be made up of several sub-layers. That is, a fibrous layer may include more than one coated fibrous (e.g., nonwoven or woven) substrate. The coated fibrous substrates may have the same composition, or may differ based on the underlying substrate (composition and/or structure) or coating or both. For example, two or more coated fibrous substrates having the same composition may be layered to achieve a desired total thickness of fibrous layer. Alternatively, two or more coated fibrous substrates having a different composition (e.g., different functionality of the hydrogel) may be layered to achieve a desired binding affinity. Likewise, two or more coated membranes having the same composition may be layered to achieve a desired total thickness of membrane layer. Two or more coated membranes having a different composition (e.g., different functionality of the hydrogel) may be layered to achieve a desired binding affinity.

The thickness of the fibrous layer and membrane layer may be selected to achieve a desired binding capacity. For example, the fibrous layer (fibrous substrate and coating combined) may have a thickness of 50 μm or greater, 100 μm or greater, or 200 μm or greater. The fibrous layer may have a thickness of 1000 μm or less, 500 μm or less, or 200 μm or less. It is often advantageous to stack a plurality of fibrous layer upstream of the membrane layer(s). The membrane layer (membrane and coating combined) may have a thickness of 25 μm or greater, 50 μm or greater, or 100 μm or greater. The membrane layer may have a thickness of 200 μm or less, 100 μm or less, or 5 μm or less. It is often advantageous to stack a plurality of membrane layers downstream of the fibrous layer(s).

The first coating may have a mass that is 0.5 wt-% or more, 1 wt-% or more, 2 wt-% or more, 5 wt-% or more, or 10 wt-% or more of the mass of the fibrous layer. The mass of the first coating may be 25 wt-% or less, 20 wt-% or less, 15 wt-% or less, or 10 wt-% or less of the mass of the fibrous layer. The mass of the first coating may be from 0.5 wt-% to 25 wt-%, 1 wt-% to 20 wt-%, 1 wt-% to 15 wt-%, 1 wt-% to 10 wt-%, 5 wt-% to 25 wt-%, 5 wt-% to 20 wt-%, or 10 wt-% to 25 wt-% of the mass of the fibrous layer.

The second coating may have a mass that is 0.5 wt-% or more, 1 wt-% or more, 2 wt-% or more, 5 wt-% or more, or 10 wt-% or more of the mass of the membrane layer. The mass of the second coating may be 25 wt-% or less, 20 wt-% or less, 15 wt-% or less, or 10 wt-% or less of the mass of the membrane layer. The mass of the second coating may be from 0.5 wt-% to 25 wt-%, 1 wt-% to 20 wt-%, 1 wt-% to 15 wt-%, 1 wt-% to 10 wt-%, 5 wt-% to 25 wt-%, 5 wt-% to 20 wt-%, or 10 wt-% to 25 wt-% of the mass of the membrane layer.

The composite separation media may further include any additional layers as desired, such as, a support layer or a scrim.

### Substrates

### Fibrous Substrates

The fibrous layer includes at least one fibrous substrate coated with a first coating including a hydrogel. A fibrous substrate is understood to mean a sheet of material made of numerous discrete fibers, each fiber having two distinct ends. Examples of fibrous substrates include nonwoven substrates and woven substrates. According to an embodiment, useful fibrous substrates have an average pore size of 100 μm or less, 75 μm or less, or 50 μm or less.

Nonwoven substrates (e.g., webs) are typically created by melt blowing, wet laying, melt spinning, solution spinning, air laying, or electrospinning. Nonwoven webs may additionally be treated through post-processing steps, such as calendaring, embossing, needle-punching, or hydroentangling. Nonwoven substrates may also contain a structural resin that has low binding affinity to biomolecules. Such resins are typically used to increase the strength of nonwoven webs. Many nonwoven substrates contain a mixture of fiber sizes (diameters) and fiber materials. The fibers used to make the nonwoven and woven substrates may include glass, polypropylene, polyamides, polyesters, cellulosic materials, and the like, and combinations thereof. The fibers may have an average fiber diameter of 0.1 μm or greater, 1 μm or greater, 2 μm or greater, or 3 um or greater. The fibers may have an average fiber diameter of 100 μm or less, 50 μm or less, 25 μm or less, 10 μm or less, or 8 μm or less. Average fiber diameters may range from 0.1 μm to 50 μm, or from 1 μm to 25 μm. The average pore size, measured by capillary flow porometer according to ASTM F316-03 (2019), may be 1 μm or greater, 2 μm or greater, or 3 μm or greater. The average pore size may be 100 μm or less, 50 μm or less, 25 μm or less, 10 μm or less, or 8 μm or less. The average pore size of suitable nonwoven substrates may range from 0.1 um to 50 μm, from 1 μm to 10 μm, or from 3 μm to 8 μm. The average pore size of woven substrates may be slightly greater than nonwoven substrates, and may range from 1 μm to 100 um. The basis weight of the fibrous substrate (e.g., nonwoven or woven media) may be 1 gsm (grams per square meter) or greater, 10 gsm or greater, or 20 gsm or greater. The basis weight of the fibrous substrate may be 200 gsm or less or 80 gsm or less. The basis weight of the fibrous substrate may be in a range of 1 gsm to 200 gsm, or from 20 gsm to 80 gsm.

### Membranes

The membrane layer includes at least one membrane coated with a second coating. The second coating may be a hydrogel. A membrane is understood as a sheet of material with a continuous pathway of polymeric material in all dimensions.

According to an embodiment, useful membranes have an average pore size, as measure by a capillary flow porometer, of 10 μm or less, 5 μm or less, or 1 μm or less. The membrane may have an average pore size of 0.05 μm or greater or 0.5 μm or greater. The membrane may have an average pore size ranging from 0.1 μm to 5 μm. The membrane may be a microfiltration membrane. Microfiltration membranes are typically created through a phase inversion process or an expansion process. Typical materials used to prepare membranes include polyethersulfone (PES), polyamide (nylon), polyvinylidene difluoride (PVDF), cellulose acetate, regenerated cellulose, polypropylene, and expanded PTFE. In some embodiments, the membrane is prepared from polyamide, polyethersulfone (PES), cellulose acetate, polyvinylidene difluoride (PVDF), or a combination of two or more thereof.

In some cases, membranes cannot tolerate a wide range of organic solvents. The membrane and coating material(s) may be selected so that the membrane is not soluble in the solvent used in the coating composition. For example, some membranes may be soluble in certain organic solvents and may not be compatible with coating compositions that contain such solvents (e.g., acetone, DMF, DMSO, or NMP) or polymers or monomers that are only soluble in such solvents.

### Binding Capacity

The layered separation media has high binding capacity to target molecules. For example, the layered separation media may have high protein binding capacity, such as BSA binding capacity. The binding capacity may be determined as a dynamic binding capacity (“DBC”) by creating a breakthrough curve for a target protein, such as BSA. A fluid (such as a low ion strength fluid, e.g., 25 mM Tris or mM phosphate) containing the target protein is passed through the membrane, typically at a flow rate of 1 cm/min, and the concentration of the target protein in the filtrate is measured and graphed as a function of loaded protein mass divided by the bed volume. The concentration of the target protein can be determined spectrophotometrically, e.g., by measuring the absorbance of the protein at 280 nm. The DBC may be given, for example, as the load that would result in a 10% breakthrough, noted as “DBC10”.

The dynamic BSA binding capacity DBC10 of the layered separation media maybe 50 mg/mL or greater, 80 mg/mL or greater, 100 mg/mL or greater, 125 mg/mL or greater, 150 mg/mL or greater, 200 mg/mL or greater, or 250 mg/mL or greater. While there is no desired upper limit for the binding capacity, in practice, the dynamic BSA binding capacity DBC10 may be 400 mg/mL or less or 350 mg/mL or less. That is, the dynamic BSA binding capacity DBC10 of the layered separation media may be in a range of 50 mg/mL to 400 mg/mL, from 100 mg/mL to 400 mg/mL, from 150 mg/mL to 400 mg/mL, or from 200 mg/mL to 350 mg/mL.

### Filter Unit

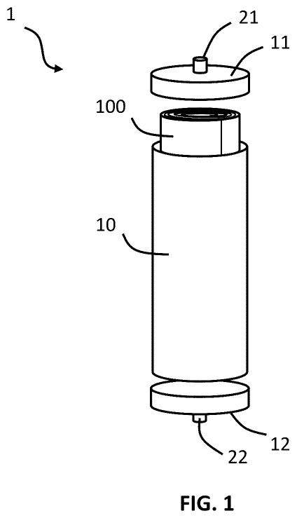

The separation media may be provided in a suitable housing or structure to provide a filter unit. The filter housing may provide an inlet, an outlet, and a flow path connecting the inlet and the outlet. The separation media may be arranged within the flow path to cause fluid flown through the filter housing to flow through the layers of the separation media. A simplified schematic of an exemplary filter unit 1 containing the separation media 100 of the present disclosure is shown in FIG. 1. The filter unit 1 includes a housing 10, first cap 11, inlet 21, second cap 12, outlet 22, and the separation media 100 disposed within the housing 10. The filter unit 1 may be a cylinder-type unit, as shown. In some embodiments, the layered separation media is housed in a spiral-wound dead-end flow conformation, such as described in WO2007145939A2.

However, other types of units and configurations may also be used, such as a flat housing units.

The filter unit may be arranged and configured in a dead end flow configuration or in a tangential flow mode.

The separation media may be provided as flat sheets. The separation media may be pleated to provide additional surface area for separation. The separation media may be wrapped (either pleated or non-pleated) around a core. The separation media may be spirally wound.

### Methods of Making

The layered separation media is generally prepared by saturation coating the fibrous substrate (e.g., non-woven media) and the membrane with the respective coating compositions, and laminating the resulting fibrous layer(s) and membrane layer(s) together. The substrates may be coated with a coating composition, where the coating composition includes a solution of a precursor polymer in a solvent. The coating composition may further include a crosslinker that may be activated after depositing the composition onto the substrate. The polymer of the coating composition may optionally be functionalized, either before or after deposition onto the substrate.

The hydrogels are generally obtained by polymerization of monomers to produce a polymer, and optionally crosslinking the polymer. The polymerization of the monomers may be performed prior to the deposition of the coating composition. The coating composition may be prepared using pre-formed polymers. According to an embodiment, the polymer forming the hydrogel (the hydrogel precursor) is soluble in a solvent. In some cases, the polymer is soluble in water. After depositing the coating composition onto the substrate, the coating composition may be cured. The curing step may include crosslinking of the hydrogel precursor to reduce its solubility. For example, crosslinking the polymer may make it non-water soluble. The polymer may be further reacted to provide desired functionality (e.g., affinity to certain target molecules) or to adjust solubility. The polymer may be further reacted first and then crosslinked, or crosslinked first and then further reacted. Alternatively, the polymer may be further reacted before deposition onto the substrate. The polymer may be a reactive polymer to facilitate crosslinking or further reaction or both. In some cases, the polymer is soluble in organic solvents but not is water soluble. In such cases, the polymer may be deposited from an organic solvent. The deposited polymer may be further reacted to increase hydrophilicity and to obtain a hydrogel. After coating of the substrate, the solvent may be removed. The solvent may optionally be replaced by another solvent (e.g., water). Alternatively, the layered separation media may be stored dry and may be wetted prior to use.

In one embodiment, a coating composition is prepared by mixing a hydrogel precursor polymer, crosslinker, and solvent (and optional additional reagents). The coating composition is deposited (e.g., saturation coated) onto a substrate, and the crosslinker is activated to cause crosslinking of the hydrogel precursor polymer. Activation of the crosslinker maybe effected by, for example, applying a source of energy, such as UV light, heat, microwaves, or gamma rays to the coating. In one example, the coating composition may be prepared by mixing polyethyleneimine, 1,4-butanedioldiglycidylether, and water, to prepare a weak anion exchange coating. In another example, the coating composition may be prepared by mixing polyethyleneimine, (3-glycidyloxypropyl)trimethoxysilane, and water, to prepare a weak anion exchange coating. In another example, the coating composition may be prepared by mixing a copolymer of 2-acrylamido-2-methyl-1-propanesulfonic acid and hydroxypropyl methacrylate deposited with dextran and water, to prepare a strong cation exchange coating. In another example, the coating composition may be prepared by mixing a copolymer of 2-acrylamido-2-methyl-1-propanesulfonic acid, hydroxypropyl methacrylate, and 3-methacryloxypropyltrimethoxysilane to prepare a strong cation exchange coating.

In one embodiment, a hydrogel precursor polymer is reacted with a reagent to functionalize the hydrogel precursor polymer. The functionalization may be performed before or after preparation of the coating composition by mixing the hydrogel precursor polymer, crosslinker, and solvent (an optional additional reagents). The coating composition is deposited (e.g., saturation coated) onto a substrate, and the crosslinker is activated to cause crosslinking of the hydrogel precursor polymer. Activation of the crosslinker maybe effected by, for example, applying a source of energy, such as UV light or heat, microwaves, or gamma rays to the coating. In one example, the coating composition may be prepared by mixing polyethyleneimine, 1,4 butanedioldiglycidylether, glycidyl trimethylammonium chloride, and water, to prepare a strong anion exchange coating. In one example, the coating composition may be prepared by mixing polyethyleneimine, 1,4 butanedioldiglycidylether, glycidyl 4-toluenesulfonate, and water, to prepare a hydrophobic interaction coating. In one example, the coating composition may be prepared by mixing polyethyleneimine, (3-glycidyloxypropyl)trimethoxysilane, glycidic acid, and water, to prepare a weak cation exchange coating.

In one embodiment, a coating composition is prepared by mixing a hydrogel precursor polymer, optional crosslinker, solvent, and one or more additional reagents. The coating composition is deposited (e.g., saturation coated) onto a substrate, and optionally the crosslinker is activated to cause crosslinking of the hydrogel precursor polymer. Activation of the crosslinker maybe effected by, for example, applying a source of energy, such as UV light or heat, microwaves, or gamma rays to the coating. The hydrogel is then functionalized by reaction of the polymer with the one or more additional reagents. In one example, the coating composition may be prepared by mixing polyglycidylmethacrylate, pentaethylenchexamine, and acetone and reacted with diethylamine in water to prepare a weak anion exchange coating. In one example, the coating composition may be prepared by mixing polyglycidylmethacrylate, pentaethylenchexamine, and acetone, and reacted with iminodiacetic acid to prepare a weak cation exchange coating. In one example, the coating composition may be prepared by mixing polyglycidylmethacrylate copolymerized with 3-Methacryloxypropyltrimethoxysilane (Dynasylan MEMO, Evonik), and acetone, and reacted with aminephenylboronate to prepare a glycan affinity coating. In one example, the coating composition may be prepared by mixing polyglycidylmethacrylate and acetone, and the polyglycidylmethacrylate may be reacted with a protein such as protein A to prepare an antibody affinity coating. In one example, the coating composition may be prepared by mixing copolymer glycidylmethacrylate and 2-(Dimethylamino)ethyl acrylate, and acetone to prepare a weak anion exchange coating.

In one embodiment, the hydrogel may be made of branched poly(ethyleneimine) crosslinked with ethylene glycol diglycidyl ether (EDGE). In one embodiment, the hydrogel may be made of (3-acrylamidopropane)-trimethylammonium chloride-co-methylenebisacrylamide (APTAC-co-BIS). In one embodiment, the hydrogel may be made of glycidyl methacrylate-co-ethylene glycol dimethacrylate (GMA-co-EDMA). In one embodiment, the hydrogel may be made of diallyldimethylammonium chloride-co-methylenebisacrylamide (DADMAC-co-BIS). In one embodiment, the hydrogel may be made of poly (acrylamide)-co-methylenebisacrylamide (AAM-co-BIS). In one embodiment, the hydrogel may be made of 2-acrylamido-2-propane-1-sulfonic acid-co-methylenebisacrylamide (AMPS-co-BIS).

In any of the coating methods discussed here, the coating composition may be applied at a suitable rate to achieve the desired outcome. In some embodiments, the first hydrogel is applied onto the non-woven media at a rate of 0.5 wt-% or greater, 1 wt-% or greater, 2 wt-% or greater, 5 wt-% or greater, or 10 wt-% or greater of the total weight of the fibrous layer. The first hydrogel may be applied onto the non-woven media at a rate of 20 wt-% or less, 15 wt-% or less, or 10 wt-% or less of the total weight of the fibrous layer. The first hydrogel may be applied onto the non-woven media at a rate of 0.5 wt-% to 20 wt-%, 1 wt-% to 20 wt-%, 2 wt-% to 20 wt-%, 5 wt-% to 20 wt-%, or 5 wt-% to 15 wt-% of the total weight of the fibrous layer. The second hydrogel may be applied onto the membrane at a rate of 0.5 wt-% or greater, 1 wt-% or greater, 2 wt-% or greater, 5 wt-% or greater, or 10 wt-% or greater of the total weight of the membrane layer. The first hydrogel may be applied onto the non-woven media at a rate of 20 wt-% or less, 15 wt-% or less, or 10 wt-% or less of the total weight of the membrane layer. The first hydrogel may be applied onto the non-woven media at a rate of 0.5 wt-% to 20 wt-%, 1 wt-% to 20 wt-%, 2 wt-% to 20 wt-%, 5 wt-% to 20 wt-%, or 5 wt-% to 15 wt-% of the total weight of the membrane layer.

### Use of the Separation Media

The separation media may be used to separate, purify, and/or filter compounds of interest, such as biomolecules, via membrane chromatography. The compounds of interest may be, for example, products or intermediates of industries such as pharmaceutical, biotechnology, food, beverage, fine chemicals, or the like. The separation media may be designed for specific uses by including various functional groups that exhibit different types of interactions with the target molecules or ions, or with compounds the target molecules or ions are to be separated from. Examples of molecules or ions that can be separated using the layered separation media include proteins, such as albumins, γ-globulins, immunoglobulins (e.g., IgG, IgM, and IgE), recombinant proteins, polypeptides, interleukin-2, enzymes, monoclonal antibodies, trypsin, cytochrome C, myoglobulin, nucleic acids (e.g., DNA and RNA), nucleic-acid derived products, endotoxins, and the like.

For example, in pharmaceutical and biotechnology industries, proteins may be produced in a cell culture or fermentation process. The proteins may first be separated from the cell culture or fermentation media by centrifugation, filtration, flocculation, extraction, etc., The separated proteins may further be purified with one or more runs through membrane chromatography, using the separation media of the present disclosure. The membrane chromatography may include one or more of various types of chromatography, such as anion separation, cation separation, size exclusion, affinity separation, etc., selected based on the compound of interest and its surrounding media.

Prior to use, the hydrogel in the first and second coatings may be swelled using water. When water is applied to the coating, the coating absorbs water and becomes a hydrogel.

Separating a target molecule from a liquid stream includes flowing the liquid stream through or across (in a tangential flow system) the layered separation media. The layered separation media includes at least one layer of hydrogel (e.g., a first coating disposed on a non-woven media, and optionally a second coating disposed on a membrane). The target molecule may be, for example, a protein. The target molecule may be, for example, albumin, y-globulin, immunoglobulin, recombinant protein, polypeptide, interleukin-2, enzyme, monoclonal antibody, trypsin, cytochrome C, myoglobulin, nucleic acid, nucleic-acid derived product, endotoxin, or a combination of two or more thereof. Flowing the liquid stream through the layered separation media causes the target molecule to bind with functional groups of the hydrogel having affinity toward the target molecule. They hydrogel may include affinity ligands having affinity toward the target molecule. The affinity ligands may include an amino acid ligand (optionally L-phenylalanine, tryptophan, or L-histidine) to separate γ-globulins and immunoglobulins, an antigen or antibody ligand (optionally monoclonal antibody, protein A, recombinant protein A, protein G, or recombinant protein G) to separate immunoglobulins, a dye ligand (optionally cibaron blue or active red) to separate albumins or enzymes, a metal affinity ligand (optionally a complex of iminodiacetic acid (IDA) ligand with Cu2+, Ni2+, Zn2+, or Co2+) to separate proteins (optionally histidine, lysozyme, or tryptophan), or an oligonucleotide for separation of complimentary oligonucleotides.

When the liquid containing the target molecule is passed through the separation media, the ligand or other binding site interacts with the target molecule, thereby absorbing the molecule or ion and/or slowing down its elution through the media. The method may further include releasing or eluting (e.g., desorbing) the target molecule from the separation media. The target molecule may be released, for example, by altering the environment, such as by changing the nature of the solvent passed through the separation media. The target molecule may be eluted by flowing an elution solution through the separation media.

### Embodiments

The following is a list of exemplary embodiments according to the present disclosure.
Embodiment 1 is a layered separation media comprising:
a fibrous layer comprising:
   a non-woven media; and
   a first coating disposed on the non-woven media, the first coating comprising a crosslinked hydrogel; and
a membrane layer comprising:
a membrane; and
   a second coating disposed on the membrane.
Embodiment 2 is the layered separation media of embodiment 1, wherein the fibrous layer is arranged on the upstream side of the membrane layer.
Embodiment 3 is the layered separation media of embodiment 1 or 2, wherein the second coating comprises a crosslinked hydrogel.
Embodiment 4 is the layered separation media of any one of the preceding embodiments, wherein the second coating has the same composition as the first coating.
Embodiment 5 is the layered separation media of any one of the preceding embodiments, wherein the crosslinked hydrogel is saturation coated onto the fibrous layer.
Embodiment 6 is the layered separation media of any one of the preceding embodiments, wherein the first coating, second coating, or both first and second coatings comprise polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenehexamine, 2-(dimethylamino)ethyl acrylate, a copolymer, a combination of any two or more thereof, or a reaction product of two or more thereof.
Embodiment 7 is the layered separation media of any one of the preceding embodiments, wherein the layered separation media comprises an anion exchange media.
Embodiment 8 is the layered separation media of any one of the preceding embodiments, wherein the layered separation media comprises a cation exchange media.
Embodiment 9 is the layered separation media of any one of the preceding embodiments, wherein the layered separation media comprises a hydrophobic interaction membrane.
Embodiment 10 is the layered separation media of any one of the preceding embodiments, wherein the layered separation media comprises a glycan affinity membrane.
Embodiment 11 is the layered separation media of any one of the preceding embodiments, wherein the layered separation media comprises an antibody affinity membrane.
Embodiment 12 is the layered separation media of any one of the preceding embodiments, wherein the layered separation media comprises an oligonucleotide affinity membrane.
Embodiment 13 is the layered separation media of any one of the preceding embodiments, wherein the layered separation media comprises mixed mode separation media.
Embodiment 14 is the layered separation media of any one of the preceding embodiments, wherein the hydrogel comprises an affinity ligand having affinity toward a target molecule.
Embodiment 15 is the layered separation media of embodiment 14, wherein the wherein the affinity ligand comprises an amino acid ligand (optionally L-phenylalanine, tryptophan, or L-histidine) to separate γ-globulins and immunoglobulins, an antigen or antibody ligand (optionally monoclonal antibody, protein A, recombinant protein A, protein G, or recombinant protein G) to separate immunoglobulins, a dye ligand (optionally cibaron blue or active red) to separate albumins or enzymes, a metal affinity ligand (optionally a complex of iminodiacetic acid (IDA) ligand with Cu2+, Ni2+, Zn2+, or Co2+) to separate proteins (optionally histidine, lysozyme, or tryptophan), or an oligonucleotide for separation of complimentary oligonucleotides.
Embodiment 16 is the layered separation media of any one of the preceding embodiments, wherein the first coating has a mass that is 0.5 wt-% or more, 1 wt-% or more, 2 wt-% or more, 5 wt-% or more, or 10 wt-% or more of a mass of the fibrous layer.
Embodiment 17 is the layered separation media of any one of the preceding embodiments, wherein the first coating has a mass that is 25 wt-% or less, 20 wt-% or less, 15 wt-% or less, or 10 wt-% or less of the mass of the fibrous layer.
Embodiment 18 is the layered separation media of any one of the preceding embodiments, wherein the second coating has a mass that is 0.5 wt-% or more, 1 wt-% or more, 2 wt-% or more, 5 wt-% or more, or 10 wt-% or more of a mass of the membrane layer.
Embodiment 19 is the layered separation media of any one of the preceding embodiments, wherein the second coating has a mass that is 25 wt-% or less, 20 wt-% or less, 15 wt-% or less, or 10 wt-% or less of the mass of the membrane layer.
Embodiment 20 is the layered separation media of any one of the preceding embodiments, wherein the non-woven media comprises glass, polypropylene, polyamide, polyester, cellulosic material, or a combination of two or more thereof.
Embodiment 21 is the layered separation media of any one of the preceding embodiments, wherein the non-woven media comprises fibers made of glass, polypropylene, polyamide, polyester, cellulosic material, or a combination of two or more thereof.
Embodiment 22 is the layered separation media of any one of the preceding embodiments, wherein the non-woven media comprises fibers has a fiber diameter of 0.1 μm or greater, 1 μm or greater, 2 μm or greater, or 3 μm or greater.
Embodiment 23 is the layered separation media of any one of the preceding embodiments, wherein the non-woven media comprises fibers has a fiber diameter of 100 μm or less, 50 μm or less, 25 μm or less, 10 μm or less, or 8 μm or less.
Embodiment 24 is the layered separation media of any one of the preceding embodiments, wherein the non-woven media has an average pore size, measured by capillary flow porometer, of 1 μm or greater, 2 μm or greater, or 3 μm or greater.
Embodiment 25 is the layered separation media of any one of the preceding embodiments, wherein the non-woven media has an average pore size, measured by capillary flow porometer, of 100 μm or less, 50 μm or less, 25 μm or less, 10 μm or less, or 8 μm or less.
Embodiment 26 is the layered separation media of any one of the preceding embodiments, wherein the non-woven media comprises fibers having a fiber diameter of 0.1 μm to 50 μm and an average pore size of 0.1 μm to 50 μm.
Embodiment 27 is the layered separation media of any one of the preceding embodiments, wherein the non-woven media has a basis weight of 1 gsm or greater, 10 gsm or greater, or 20 gsm or greater.
Embodiment 28 is the layered separation media of any one of the preceding embodiments, wherein the non-woven media has a basis weight of 200 gsm or less or 80 gsm or less.
Embodiment 29 is the layered separation media of any one of the preceding embodiments, wherein the membrane comprises one or more of polyethersulfone (PES), polyamide (nylon), polyvinylidene difluoride (PVDF), cellulose acetate, regenerated cellulose, polypropylene, and expanded PTFE.
Embodiment 30 is the layered separation media of any one of the preceding embodiments, wherein the membrane comprises cellulose acetate.
Embodiment 31 is the layered separation media of any one of the preceding embodiments, wherein the layered separation media has a DBC10 of 50 mg/mL or greater, 80 mg/mL or greater, 100 mg/mL or greater, 125 mg/mL or greater, 150 mg/mL or greater, 200 mg/mL or greater, or 250 mg/mL or greater, measured using bovine serum albumin.
Embodiment 32 is the layered separation media of any one of the preceding embodiments, wherein the layered separation media has a DBC10 of 400 mg/mL or less or 350 mg/mL or less, measured using bovine serum albumin.
Embodiment 33 is the layered separation media of any one of the preceding embodiments, wherein the layered separation media is housed in a spiral-wound dead-end flow conformation.
Embodiment 34 is a filter unit comprising the layered separation media of any one of the preceding embodiments.
Embodiment 35 is the filter unit of embodiment 34 further comprising a housing comprising an inlet and an outlet and defining a flow path, wherein the layered separation media is disposed in the flow path within the housing.
Embodiment 36 is a system for membrane chromatography comprising the layered separation media of any one of the preceding embodiments.
Embodiment 37 is a system for membrane chromatography comprising:
a layered separation media comprising:
   a fibrous layer comprising:
      a non-woven media; and
      a first coating disposed on the non-woven media, the first coating comprising a hydrogel; and
   a membrane layer comprising:
      a membrane; and
      a second coating disposed on the membrane.
Embodiment 38 is a method of preparing a layered separation media, the method comprising:
preparing a fibrous layer by:
   applying a first hydrogel onto a non-woven media; and
   optionally crosslinking the first hydrogel;
preparing a membrane layer by:
   applying a second hydrogel onto a membrane; and
   optionally crosslinking the second hydrogel; and
combining the fibrous layer with them membrane layer to form the layered separation media.
Embodiment 39 is the method of embodiment 38, wherein the preparing of the fibrous layer, the membrane layer, or both comprises crosslinking.
Embodiment 40 is the method of embodiment 38 or 39, wherein the applying of the first hydrogel onto the non-woven media comprises saturation coating the non-woven media with the first hydrogel.
Embodiment 41 is the method of any one of embodiments 38 to 40, wherein the first hydrogel is applied onto the non-woven media at a rate of 0.5 wt-% or greater, 1 wt-% or greater, 2 wt-% or greater, 5 wt-% or greater, or 10 wt-% or greater of the total weight of the fibrous layer.
Embodiment 42 is the method of any one of embodiments 38 to 41, wherein the first hydrogel is applied onto the non-woven media at a rate of 20 wt-% or less, 15 wt-% or less, or 10 wt-% or less of a total weight of the fibrous layer.
Embodiment 43 is the method of embodiment 38 or 42, wherein the applying of the second hydrogel onto the membrane comprises saturation coating the membrane with the second hydrogel.
Embodiment 44 is the method of any one of embodiments 38 to 43, wherein the second hydrogel is applied onto the membrane at a rate of 0.5 wt-% or greater, 1 wt-% or greater, 2 wt-% or greater, 5 wt-% or greater, or 10 wt-% or greater of a total weight of the membrane layer.
Embodiment 45 is the method of any one of embodiments 38 to 44, wherein the second hydrogel is applied onto the membrane at a rate of 20 wt-% or less, 15 wt-% or less, or 10 wt-% or less of the total weight of the membrane layer.
Embodiment 46 is the method of any one of embodiments 38 to 45, comprising preparing the first hydrogel, the second hydrogel, or both first and second hydrogels from a polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenehexamine, 2-(dimethylamino) ethyl acrylate, a copolymer of two or more thereof, a combination of two or more thereof, or reaction product of two or more thereof.
Embodiment 47 is the method of any one of embodiments 38 to 46, comprising preparing the first hydrogel, the second hydrogel, or both first and second hydrogels from polyethyleneimine (PEI); a copolymer of 2-acrylamido-2-methyl-1-propanesulfonic acid and hydroxypropyl methacrylate; a copolymer of 2-acrylamido-2-methyl-1-propanesulfonic acid, hydroxypropyl methacrylate, and 3-methacryloxypropyltrimethoxysilane; polyglycidylmethacrylate; a copolymer of polyglycidylmethacrylate copolymerized with 3-methacryloxypropyltrimethoxysilane; a copolymer of glycidylmethacrylate and 2-(dimethylamino)ethyl acrylate; or a combination of two or more thereof.
Embodiment 48 is the method of any one of embodiments 38 to 47, wherein the preparing one or both of the fibrous layer and the membrane layer comprises depositing a precursor with a crosslinker comprising 1,4-butanedioldiglycidylether, epoxymethoxysilane (optionally (3-glycidyloxypropyl)trimethoxysilane), dextran, 3-methacryloxypropyltrimethoxysilane, pentaethylenehexamine, or a combination of two or more thereof.
Embodiment 49 is the method of any one of embodiments 38 to 48, wherein the preparing one or both of the fibrous layer and the membrane layer comprises depositing polyethyleneimine (PEI) with a crosslinker, optionally wherein the crosslinker comprises 1,4-butanedioldiglycidylether or epoxymethoxysilane, optionally wherein the resulting hydrogel comprises a weak anion exchange membrane.
Embodiment 50 is the method of any one of embodiments 38 to 49, wherein the preparing one or both of the fibrous layer and the membrane layer comprises depositing a copolymer of 2-acrylamido-2-methyl-1-propanesulfonic acid and hydroxypropyl methacrylate with a crosslinker, optionally wherein the crosslinker comprises dextran or 3-methacryloxypropyltrimethoxysilane, optionally wherein the resulting hydrogel comprises a strong cation exchange membrane.
Embodiment 51 is the method of any one of embodiments 38 to 50, wherein the preparing one or both of the fibrous layer and the membrane layer comprises forming the hydrogel by reacting a precursor polymer with a reactant comprising a functional group prior to the crosslinking.
Embodiment 52 is the method of embodiment 51, wherein reacting the precursor polymer with a reactant provides the hydrogel with functionalization comprising one or more amines, alcohols, carboxylic acids, sodium sulfite, anhydrides, or thiols.
Embodiment 53 is the method of any one of embodiments 38 to 52, wherein the preparing one or both of the fibrous layer and the membrane layer comprises reacting polyethyleneimine with glycidyl trimethylammonium chloride to form a functionalized polyethyleneimine, and depositing the functionalized polyethyleneimine optionally with a crosslinker, optionally wherein the crosslinker comprises 1,4-butanedioldiglycidylether, optionally wherein the resulting hydrogel comprises a strong anion exchange membrane.
Embodiment 54 is the method of any one of embodiments 38 to 53, wherein the preparing one or both of the fibrous layer and the membrane layer comprises reacting polyethyleneimine with glycidyl 4-toluenesulfonate to form a functionalized polyethyleneimine, and depositing the functionalized polyethyleneimine optionally with a crosslinker, optionally wherein the crosslinker comprises 1,4-butanedioldiglycidylether, optionally wherein the resulting hydrogel comprises a hydrophobic interaction membrane.
Embodiment 55 is the method of any one of embodiments 38 to 54, wherein the preparing one or both of the fibrous layer and the membrane layer comprises reacting polyethyleneimine with glycidic acid to form a functionalized polyethyleneimine, and depositing the functionalized polyethyleneimine optionally with a crosslinker, optionally wherein the crosslinker comprises epoxymethoxysilane, optionally wherein the resulting hydrogel comprises a weak cation exchange membrane.
Embodiment 56 is the method of any one of embodiments 38 to 55, wherein the preparing one or both of the fibrous layer and the membrane layer comprises reacting the first hydrogel, second hydrogel, or both with a reactant to form a functionalized hydrogel, optionally wherein the hydrogel is reacted after crosslinking.
Embodiment 57 is the method of any one of embodiments 38 to 56, wherein the preparing one or both of the fibrous layer and the membrane layer comprises depositing polyglycidylmethacrylate with a crosslinker to form the crosslinked hydrogel and reacting the crosslinked hydrogel with diethylamine or iminodiacetic acid, optionally wherein the crosslinker comprises pentaethylenehexamine, optionally wherein the resulting hydrogel comprises a weak anion exchange membrane.
Embodiment 58 is the method of any one of embodiments 38 to 57, wherein the preparing one or both of the fibrous layer and the membrane layer comprises depositing polyglycidylmethacrylate copolymerized with 3-methacryloxypropyltrimethoxysilane to form the hydrogel and reacting the hydrogel with aminephenylboronate, optionally wherein the resulting hydrogel comprises a glycan affinity membrane.
Embodiment 59 is the method of any one of embodiments 38 to 58, wherein the preparing one or both of the fibrous layer and the membrane layer comprises reacting polyglycidylmethacrylate with a protein, optionally wherein the resulting hydrogel comprises an antibody affinity membrane.
Embodiment 60 is the method of any one of embodiments 38 to 59, wherein the preparing one or both of the fibrous layer and the membrane layer comprises depositing glycidylmethacrylate and 2-(dimethylamino) ethyl acrylate to form a copolymer, optionally wherein the resulting hydrogel comprises a weak anion exchange membrane.
Embodiment 61 is the method of any one of embodiments 38 to 60, wherein the layered separation media comprises an anion exchange media.
Embodiment 62 is the method of any one of embodiments 38 to 61, wherein the layered separation media comprises a cation exchange media.
Embodiment 63 is the method of any one of embodiments 38 to 62, wherein the layered separation media comprises a hydrophobic interaction membrane.
Embodiment 64 is the method of any one of embodiments 38 to 63, wherein the layered separation media comprises a glycan affinity membrane.
Embodiment 65 is the method of any one of embodiments 38 to 64, wherein the layered separation media comprises an antibody affinity membrane.
Embodiment 66 is the method of any one of embodiments 38 to 65, wherein the layered separation media comprises mixed mode separation media.
Embodiment 67 is a method of separating a target molecule from a liquid stream comprising:
flowing the liquid stream through the layered separation media of any one of the preceding embodiments.
Embodiment 68 is a method of separating a target molecule from a liquid stream comprising:
flowing the liquid stream through a layered separation media comprising:
   a fibrous layer comprising:
      a non-woven media; and
      a first coating disposed on the non-woven media, the first coating comprising a hydrogel; and
   a membrane layer comprising:
      a membrane; and
      a second coating disposed on the membrane,
wherein the layered separation media has a DBC10 of 50 mg/mL or greater, measured using bovine serum albumin as the protein.
Embodiment 69 is the method of any one of embodiments 67 to 68, wherein the target molecule is a protein.
Embodiment 70 is the method of any one of embodiments 67 to 69, wherein flowing the liquid stream through the layered separation media causes the target molecule to bind with a functional group of the hydrogel having affinity toward the target molecule.
Embodiment 71 is the method of any one of embodiments 67 to 70, wherein the target molecule comprises albumin, γ-globulin, immunoglobulin, recombinant protein, polypeptide, interleukin-2, enzyme, monoclonal antibody, trypsin, cytochrome C, myoglobulin, nucleic acid, nucleic-acid derived product, endotoxin, or a combination of two or more thereof.
Embodiment 72 is the method of any one of embodiments 67 to 71, wherein the second coating comprises a second hydrogel.
Embodiment 73 is the method of any one of embodiments 67 to 72, wherein the hydrogel and optionally the second hydrogel comprises an affinity ligand having affinity toward the target molecule.
Embodiment 74 is the method of embodiment 73, wherein the wherein the affinity ligand comprises an amino acid ligand (optionally L-phenylalanine, tryptophan, or L-histidine) to separate γ-globulins and immunoglobulins, an antigen or antibody ligand (optionally monoclonal antibody, protein A, recombinant protein A, protein G, or recombinant protein G) to separate immunoglobulins, a dye ligand (optionally cibaron blue or active red) to separate albumins or enzymes, a metal affinity ligand (optionally a complex of iminodiacetic acid (IDA) ligand with Cu2+, Ni2+, Zn2+, or Co2+) to separate proteins (optionally histidine, lysozyme, or tryptophan), or an oligonucleotide for separation of complimentary oligonucleotides.
Embodiment 75 is the method of any one of embodiments 67 to 74, wherein flowing the liquid stream through the layered separation media comprises dead-end filtration.
Embodiment 76 is the method of any one of embodiments 67 to 75, wherein flowing the liquid stream through the layered separation media comprises tangential flow filtration.
Embodiment 77 is the method of any one of embodiments 67 to 76 further comprising eluting the target molecule by flowing an elution solution through the separation media.

### EXAMPLES

### Example 1

The binding capacity of layered separation media prepared according to the present disclosure was evaluated against a coated membrane and a coated non-woven substrate.

The layered separation media was prepared by making a membrane layer coating solution and a fibrous layer coating solution. The fibrous layer had a larger pore size than the membrane layer and could, therefore, be coated with a higher solids content solution. The membrane layer coating solution was made by mixing 0.8 g of polyethyleneimine (50% solution in water) having an average molecular weight (mn) 60000 and (mw) 750000, available from Sigma Aldrich, with 0.828 mL of glycidyltrimethylammonium chloride, available from Sigma Aldrich, in 18.3 mL of water for 16 hours at 36° C. After the reaction was stopped, 20.2 μL of 1,4-butanedioldigycidyl ether was added. The fibrous layer coating solution was prepared similarly but at a 6-fold concentration of each ingredient.

A 0.2 μm nominal pore size cellulose acetate membrane sourced from Sterlitech was used as the membrane substrate. A fibrous substrate was formulated by wet laying a composition of 50% by weight TJ04BN 2 d×5 mm fiber sourced from Teijin and 50% by weight B-04-F microglass fiber sourced from Unifrax, at a thickness of 48 g/m². The substrates were saturated with their respective coating solutions for about 10 seconds in a coating bath, removed from the coating bath, and the excess coating was allowed to drain. The substrates were then placed into an oven at 80° C. for 40 minutes for curing. Following curing, the substrates were extracted in water at 100° C. for 1 hour.

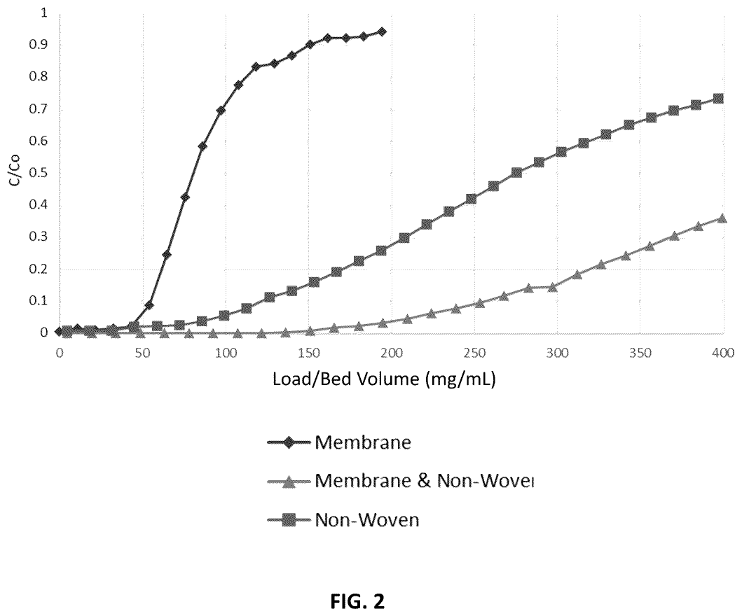

Samples were tested for dynamic binding capacity with an Akta Avant 150 FPLC from Cytiva. Each sample contained 3 layers of either fibrous substrate, membrane, or a combination of substrates. Samples were conditioned by flowing 25 mL of Tris buffer at pH 8 at a flowrate of 1 mL/min. Following conditioning samples were loaded with bovine serum albumin (BSA) at a feed concentration of 1000 ppm at a flowrate of 1 mL/min with a 25 mm diameter filter holder. The breakthrough curve is shown in FIG. 2. In the graph, x-axis represents the amount of protein fed to the sample normalized by bed volume of the composite sample and y-axis represents the absorbance of the filtrate at 280 nm and is indicative of the concentration of BSA. The data set referred to as “membrane” is 3 stacked layers of the coated membrane. The data set referred to as “non-woven” is 3 stacked layers of the coated fibrous substrate. The data set referred to “membrane and non-woven” is 2 layers of the coated fibrous substrate upstream of a single layer of coated membrane.

It was observed that the combination of a hydrogel coated fibrous layer subsequently followed by a hydrogel coated membrane layer demonstrated protein dynamic binding capacity significantly higher than either layer tested individually. This result is unexpected as the dynamic binding capacity value is normalized by the sample volume. These results indicate that the hydrogel coated composite structure is able to better utilize the inherent volume of the coating.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A layered separation media comprising:
a fibrous layer comprising:
a non-woven media; and
a first coating disposed on the non-woven media, the first coating comprising a crosslinked hydrogel; and
a membrane layer comprising:
a membrane; and
a second coating disposed on the membrane.

2. The layered separation media of claim 1, wherein the fibrous layer is arranged on an upstream side of the membrane layer.

3. The layered separation media of claim 1, wherein the second coating comprises a second crosslinked hydrogel.

4. The layered separation media of claim 1, wherein the second coating has the same composition as the first coating.

5. The layered separation media of claim 1, wherein the first coating, second coating, or both first and second coatings comprise polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenehexamine, 2-(dimethylamino)ethyl acrylate, a copolymer of two or more thereof, a combination of two or more thereof, or a reaction product of two or more thereof.

6. The layered separation media of claim 1, wherein the layered separation media comprises an anion exchange media, a cation exchange media, or both.

7. The layered separation media of claim 1, wherein the layered separation media comprises a hydrophobic interaction membrane, a glycan affinity membrane, an antibody affinity membrane, an oligonucleotide affinity membrane, or a combination thereof.

8. The layered separation media of claim 1, wherein the layered separation media comprises mixed mode separation media.

9. The layered separation media of claim 1, wherein the first coating has a mass that is from 0.5 wt-% to 25 wt-% of a mass of the fibrous layer, wherein the second coating has a mass that is from 0.5 wt-% to 25 wt-% of a mass of the membrane layer, or both.

10. The layered separation media of claim 1, wherein the non-woven media comprises glass, polypropylene, polyamide, polyester, cellulosic material, or a combination of two or more thereof, optionally wherein the non-woven media comprises fibers has a fiber diameter of 0.1 μm to 50 μm and an average pore size of 0.1 μm to 50 μm.

11. The layered separation media of claim 1, wherein the membrane comprises one or more of polyamide, polyethersulfone (PES), cellulose acetate, and polyvinylidene difluoride (PVDF).

12. The layered separation media of claim 1, wherein the layered separation media has a DBC10 of 50 mg/mL or greater, measured using bovine serum albumin.

13. A system for membrane chromatography comprising:
a layered separation media comprising:
a fibrous layer comprising:
a non-woven media; and
a first coating disposed on the non-woven media, the first coating comprising a hydrogel; and
a membrane layer comprising:
a membrane; and
a second coating disposed on the membrane.

14. A method of preparing a layered separation media, the method comprising:
preparing a fibrous layer by:
applying a first hydrogel onto a non-woven media; and
optionally crosslinking the first hydrogel;
preparing a membrane layer by:
applying a second hydrogel onto a membrane; and
optionally crosslinking the second hydrogel; and
combining the fibrous layer with them membrane layer to form the layered separation media.

15. The method of claim 14, wherein the first hydrogel, the second hydrogel, or both, is applied at a rate of 0.5 wt-% to 20 wt-% of a total weight of the fibrous layer or the membrane layer, respectively.

16. The method of claim 14, comprising preparing the first hydrogel, the second hydrogel, or both first and second hydrogels from polyethyleneimine (PEI), 2-acrylamido-2-methyl-1-propanesulfonic acid, hydroxypropyl methacrylate, 3-methacryloxypropyltrimethoxysilane, glycidylmethacrylate, polyglycidylmethacrylate, pentaethylenehexamine, 2-(dimethylamino)ethyl acrylate, or a copolymer of two or more thereof, combination of two or more thereof, or reaction product of two or more thereof.

17. The method of claim 14, wherein the preparing one or both of the fibrous layer and the membrane layer comprises depositing polyethyleneimine (PEI) with a crosslinker, optionally wherein the crosslinker comprises 1,4-butanedioldiglycidylether or epoxymethoxysilane, optionally wherein the resulting hydrogel comprises a weak anion exchange membrane.

18. The method of claim 14, wherein the preparing one or both of the fibrous layer and the membrane layer comprises depositing a copolymer of 2-acrylamido-2-methyl-1-propanesulfonic acid and hydroxypropyl methacrylate with a crosslinker, optionally wherein the crosslinker comprises dextran or 3-methacryloxypropyltrimethoxysilane, optionally wherein the resulting hydrogel comprises a strong cation exchange membrane.

19. The method of claim 14, wherein the preparing one or both of the fibrous layer and the membrane layer comprises reacting polyethyleneimine with glycidyl trimethylammonium chloride to form a functionalized polyethyleneimine, and depositing the functionalized polyethyleneimine optionally with a crosslinker, optionally wherein the crosslinker comprises 1,4-butanedioldiglycidylether, optionally wherein the resulting hydrogel comprises a strong anion exchange membrane.

20. The method of claim 14, wherein the preparing one or both of the fibrous layer and the membrane layer comprises reacting polyethyleneimine with glycidyl 4-toluenesulfonate to form a functionalized polyethyleneimine, and depositing the functionalized polyethyleneimine optionally with a crosslinker, optionally wherein the crosslinker comprises 1,4-butanedioldiglycidylether, optionally wherein the resulting hydrogel comprises a hydrophobic interaction membrane.

21. The method of claim 14, wherein the preparing one or both of the fibrous layer and the membrane layer comprises reacting polyethyleneimine with glycidic acid to form a functionalized polyethyleneimine, and depositing the functionalized polyethyleneimine optionally with a crosslinker, optionally wherein the crosslinker comprises epoxymethoxysilane, optionally wherein the resulting hydrogel comprises a weak cation exchange membrane.

22. The method of claim 14, wherein the preparing one or both of the fibrous layer and the membrane layer comprises depositing polyglycidylmethacrylate with a crosslinker to form the crosslinked hydrogel and reacting the crosslinked hydrogel with diethylamine or iminodiacetic acid, optionally wherein the crosslinker comprises pentaethylenehexamine, optionally wherein the resulting hydrogel comprises a weak anion exchange membrane.

23. The method of claim 14, wherein the preparing one or both of the fibrous layer and the membrane layer comprises depositing polyglycidylmethacrylate copolymerized with 3-methacryloxypropyltrimethoxysilane to form the hydrogel and reacting the hydrogel with aminephenylboronate, optionally wherein the resulting hydrogel comprises a glycan affinity membrane.

24. The method of claim 14, wherein the preparing one or both of the fibrous layer and the membrane layer comprises reacting polyglycidylmethacrylate with a protein, optionally wherein the resulting hydrogel comprises an antibody affinity membrane.

25. The method of claim 14, wherein the preparing one or both of the fibrous layer and the membrane layer comprises depositing glycidylmethacrylate and 2-(dimethylamino) ethyl acrylate to form a copolymer, optionally wherein the resulting hydrogel comprises a weak anion exchange membrane.

26. A method of separating a protein from a liquid stream comprising:
flowing the liquid stream through a layered separation media comprising:
a fibrous layer comprising:
a non-woven media; and
a first coating disposed on the non-woven media, the first coating comprising a hydrogel; and
a membrane layer comprising:
a membrane; and
a second coating disposed on the membrane.
